(19) United States
(12) Patent Application Publication
(10) Pub. No.: US 2016/0006235 A1
(43) Pub. Date: Jan. 7, 2016

(54) ANTI-LIGHTNING STROKE OVERCURRENT PROTECTION SWITCH

(71) Applicant: YI-HSIANG WANG, TAOYUAN COUNTY (TW)

(72) Inventor: YI-HSIANG WANG, TAOYUAN COUNTY (TW)

(21) Appl. No.: 14/324,432

(22) Filed: Jul. 7, 2014

(51) Int. Cl. H02H 3/38; H01C 7/12

(52) U.S. Cl. CPC H02H 3/38; H01C 7/12

(57) ABSTRACT

An anti-lightning stroke overcurrent protection switch comprises an overcurrent protection switch with an overvoltage protection sensor disposed inside and operated by one of the conductive plates. The overvoltage protection sensor comprises a metal oxide varistor and an insulating thermosensitive piece, disposed at one side of the operating portion of the conductive plate; on the other side a spring is arranged, providing the elastic force to hold the position of the thermosensitive piece. When the metal oxide varistor rises up the temperature to a certain degree due to high voltages, the thermosensitive piece would melt instantly due to its large contact surface and rapid heat conduction, resulting the elastic force counterbalanced and assuring the switch to be turned off before reaching an exceeding high degree of temperature, further improving safety of the present invention.

### BACKGROUND OF THE INVENTION

1. Field of the Invention

The present invention relates to an anti-lightning stroke overcurrent protection switch, particularly to one that has a built-in overvoltage protection sensor which has a thermosensitive piece with large contact area and rapid heat conduction to assure the device to be turned off before reaching an exceeding high degree of temperature.

2. Description of the Related Art

FIGS. 1A and 1B disclose an overcurrent protection switch 10, comprising a housing 11 with a press button 12 on the top, a first terminal 12a, a second terminal 12b, a third terminal 12c at the bottom, and a moving element 14. The first terminal 12a has a bimetal plate 13 and a first contact 131; the second terminal 12b has a second contact 121 corresponding to the first contact 131. The moving element 14 is arranged vertically, linking the bottom of the press button 12 with one end and the moving terminal of the bimetal plate 13 with the other, whereby the pressing of the press button 12 actuates the first contact 131 connecting to the second contact 121 and therefore turns on the device; while overcurrent occurs, the bimetal plate 13 deforms due to high degree of temperature and disconnects the first and second contact 131, 121, turning off the device so as to form an overcurrent protection switch 10. Such structure can be found in Taiwan patent applications No. 540811, 367091, 320335, 262168, and 208384. However, the structure disclosed above aims at protection from overcurrent situation but is not able to protect the device when sudden overvoltage such as lightning stroke occurs.

Therefore, for safety concern, a usual solution to the defect is to connect a metal oxide varistor and a thermal fuse to the device.

FIGS. 2A, 2B, and 2C illustrate the structure of a thermal fuse according to the prior art. It comprises a metallic casing 20 having one end opening with a first lead member 201 fixed thereto and the other end opening with a second lead member 202 crimped and thus fixed thereto. The first lead member 201, fixed via an insulating bushing 27, is insulated from the metallic casing 20 and extends therein, having an end provided with a first electrode 25. The first lead member 201 has an externally guided portion provided with an insulated bushing 29 for protection fixed with resin seal 28 at an opening of the metallic casing 20. The second lead member 202 is crimped directly and fixed in connection with the casing 20 which also accommodates a switching function member including thermosensitive pellet 21 and a spring member including strong and week springs 26, 23 respectively. The thermal fuse is actuated by the first and second lead member 201, 202 connected by conducting wires. When the temperature reaches a pre-determined degree, the thermosensitive pellet 21 would melt instantly and therefore displace a pressure plate 22 by a strong compression spring 23, counterbalancing the force made by the weak and strong compression springs 23, 26 and pushing the first electrode 25 away, thus breaking the circuit since the first electrode 25 is disconnected to the fixed first lead member 201. Such structure can be found in Taiwan patent applications No.

The structure mentioned above is able to protect the device from both overcurrent and overvoltage situations, but it requires indirect heat conduction wrapping of both the metal oxide varistor and thermal fuse. The wrapping method and contact area are influential factors on the heat conduction and the related operation of the device. Besides, during the welding process, it is also vital to make sure that the thermal fuse would not melt due to the welding heat; therefore, the working space has to be large enough, making it more inconvenient in the constructing process.

In FIG. 2D, a conventional method of anti-surge disconnection is to tie up a surge absorber 101 and a thermal fuse 102 by a heat shrinkable sleeve 103 to make sure the surge absorber 101 would rise up the temperature quickly and conduct the heat to the thermal fuse 102, melting the substance inside thereof and therefore breaking the circuit. In such structure if the heat is not well conducted due to ineffective contact, the thermal fuse 102 may not function fast enough to disconnect the circuit and the surge absorber 101 keeps rising up the temperature till being damaged. Moreover, such defect cannot be detected in the quality control process.

FIG. 2E is another conventional method of an anti-surge disconnection. It has an elastic strip 103 tying up a surge absorber 101 and two flexible conducting plates 104 in order to connect the circuit. When the surge absorber 101 rises up the temperature due to lightning stroke, the elastic strip 103 would melt slowly, thus disconnect the flexible conducting plates 104 and the main power supply. The elastic strip 103 would burn up but the burning would stop eventually since it is inside a fireproof enclosed space 100.

FIG. 2F discloses an anti-surge switch module applied in an electric system. The switch module comprises a power switch 105, an insulating member 106, a surge absorber 107 and a pyrocondensation belt 108. The insulating member 106 engages with the power switch 105 that abutting against the surge absorber 107; and the pyrocondensation belt 108 ties the surge absorber 107 and the insulating member 106 together so that it could contract when receiving the heat from the surge absorber 107 and thus turn off the power switch 105 under certain degree of contracting. Such structure can be found in U.S. Pat. No. 8,643,462.

In short, all the structures disclosed above have shortcomings as uncertain quality, possible exceeding heat, slow reaction, large volumes, and complicated composition, and it requires more constructing space and procedures. Besides, the protection device has to be connected independently outside instead of having one inside.

In UL 1449 3^{rd} Edition (2009) Type 4 was added to Surge Protective Devices (SPDs) requirements. The 3^{rd} Edition also includes the Low voltage Surge Arrestres under 1000 V in the requirements, and the title is also altered from Transient Voltage Surge Suppressors into Surge Protective Devices. This shows the importance of the components being integrated and the surge arrestres function.

Hence, it is desirable of the present invention to construct an overvoltage protection sensor built inside an overcurrent protection switch 10 so that the heat could be conducted directly to the heat sensor device instead of indirectly via an outside thermal fuse, and the heat conduction effect needs to be improved in order to make sure the device operates successfully.

### SUMMARY OF THE INVENTION

A primary object of the present invention is to provide an anti-lightning stroke overcurrent protection switch that has an overvoltage protection sensor as well to ensure safety for electronic devices.

Another object of the present invention is to provide an anti-lightning stroke overcurrent protection switch with a thermosensitive piece that has a direct contact to conduct the heat fast enough so that the device could be turned off immediately before the metal oxide varistor reaches an exceeding degree of temperature, further ensures safety of the device as well.

To achieve the objects mentioned above, the present invention comprises a housing, a moving rod, an overvoltage protection sensor, and a spring. The housing has a press button, a first conductive plate, a second conductive plate, and a third conductive plate; said first conductive plate has a binary alloy conductive spring leaf and a first connecting point and said second conductive plate has a second connecting point at top corresponding to said first connecting point; the moving rod links up the bottom of said press button with one end and a movable end of said binary alloy conductive spring leaf with the other end, whereby the press button pressing said binary alloy conductive spring leaf and connecting the first connecting point and the second connecting point, turning on the switch, and when current overload happens the binary alloy conductive spring leaf would deform due to high degree of temperature, moving said first connecting point and the second connecting point apart, thus turning off the switch, so as to form an overcurrent protection switch; wherein said second conductive plate includes an extending portion stretching out the housing and an operating portion inside thereof; said operating portion further has an upper section fixed by said second connecting point and a lower section which includes a first side and a second side and is electrically connected to said upper section; said second side is partially contacting the extending portion via electrical connection but is separable; the overvoltage protection sensor comprises a metal oxide varistor and a thermosensitive piece; said metal oxide varistor is unwrapped and has a first surface on one side and a second surface on the other; said thermosensitive piece is made of heat-sensitive materials, which would melt immediately when reaching a pre-determined temperature degree during operation, and the bottom of the thermosensitive piece fits the second surface of said metal oxide varistor, further makes the first surface thereof fitting a contact surface of said third conductive plate, forming an electrical contact; the front of said thermosensitive piece faces and partially contacts the first side of said lower section; the spring has a first end at one side and a second end at the other, and is arranged on the second side of said lower section; the second end thereof abuts a holding surface arranged in the housing, providing the elastic force for the spring to hold said thermosensitive piece; whereby the thermosensitive piece melts when an overvoltage occurs and the temperature of said metal oxide varistor rises up to the pre-determined degree while the switch is operating by the connection between the first connecting point and the second connecting point, counterbalancing the elastic force and further displacing the operating portion, therefore separating the first conductive plate and the second conductive plate, turning off the switch.

In an applicable embodiment, the upper section and lower section of the operating portion are arranged in L-shape or curved shape, and the joint thereof has a hinge hole for a pivot stick from the housing to engage, making the operating portion as a seesaw; in another applicable embodiment, the lower section and the extending portion are joined by a third connecting point and a fourth connecting point respectively.

In a preferred embodiment, the thermosensitive piece is conical as the bottom arranged as a flat surface and the front a pointed end; and the first side of the lower section has a springy piece contacting the thermosensitive piece by fitting the front thereof into a positioning hole on said springy piece in another applicable embodiment. The thermosensitive piece further has an insulation cap at the front.

As structures disclosed above, the present invention complements the defect of a conventional overcurrent protection switch that it has to connect to a thermal fuse and a metal oxide varistor form outside by disposing an overvoltage protection sensor inside. When receiving high voltages, the operating portion of second conductive plate would be quickly displaced and thus turning off the output terminal Meanwhile, the heating metal oxide varistor combining with the contact with thermosensitive piece melting in instant high temperature assure the device to be turned off before reaching an exceeding high degree of temperature. The design of an overvoltage protection sensor inside an overcurrent protection switch has improved both safety and convenience of electronic devices.

### BRIEF DESCRIPTION OF THE DRAWINGS

FIG. 1A is a perspective view of an overcurrent protection switch according to the prior art;

FIG. 1B is a section view of an overcurrent protection switch according to the prior art;

FIG. 2A is a perspective view of a thermal fuse according to the prior art;

FIG. 2B is a section view of a thermal fuse in an on status according to the prior art;

FIG. 2C is a section view of a thermal fuse in an off status according to the prior art;

FIG. 2D is a schematic diagram of an anti-lightning stoke method according to the prior art;

FIG. 2E is another schematic diagram of an anti-lightning stoke method according to the prior art;

FIG. 2F is a schematic diagram of an anti-lightning stoke method according to U.S. Pat. No. 8,643,462;

FIG. 3 is a section view of a preferred embodiment of the present invention in an OFF status;

FIG. 4 is a section view of a preferred embodiment of the present invention in an ON status;

FIG. 5 is an application example of the present invention illustrating the thermosensitive piece melting and displacement of the operation portion turning the switch off;

FIG. 6 is an exploded view of the major components in a preferred embodiment of the present invention.

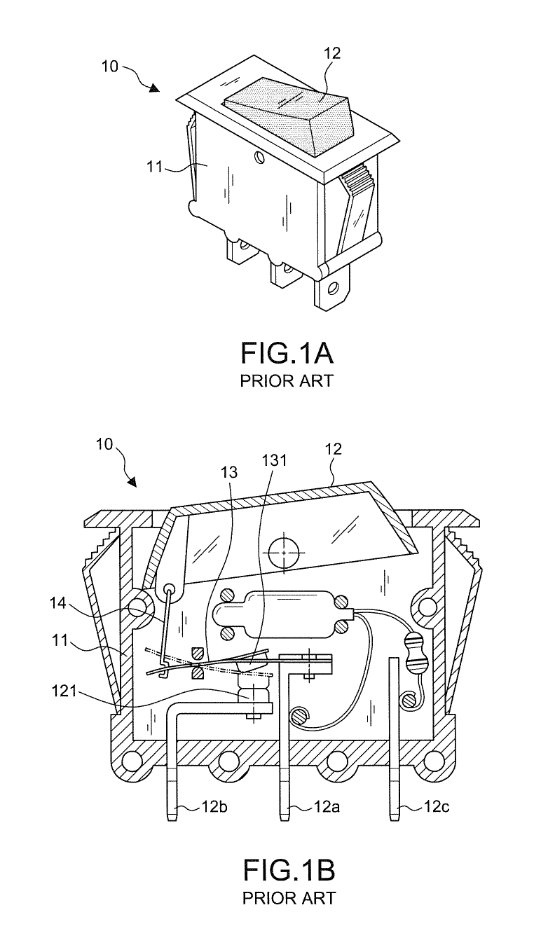

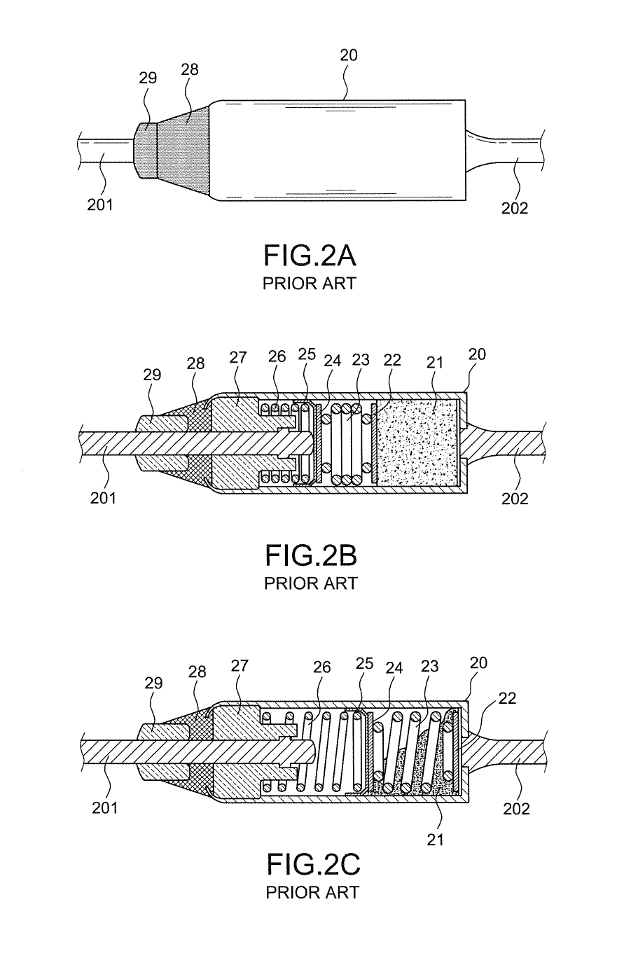

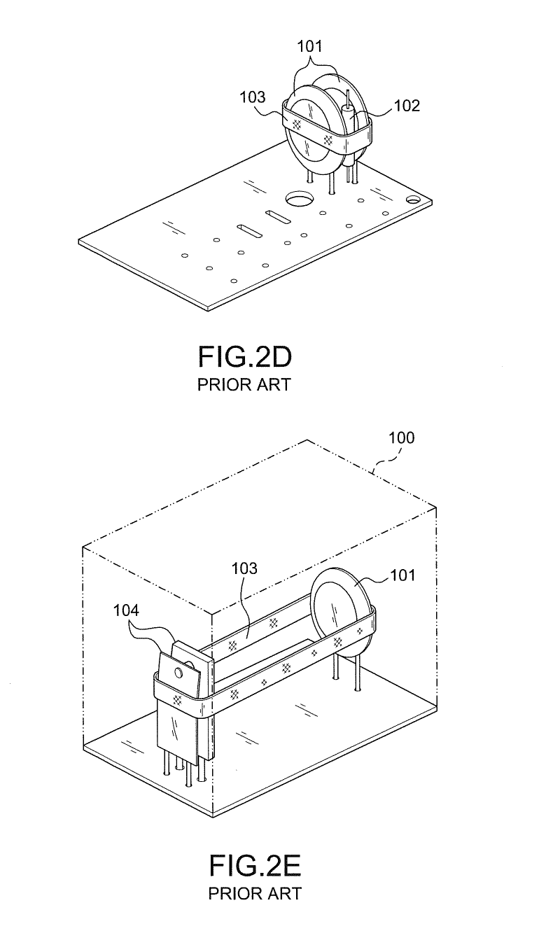

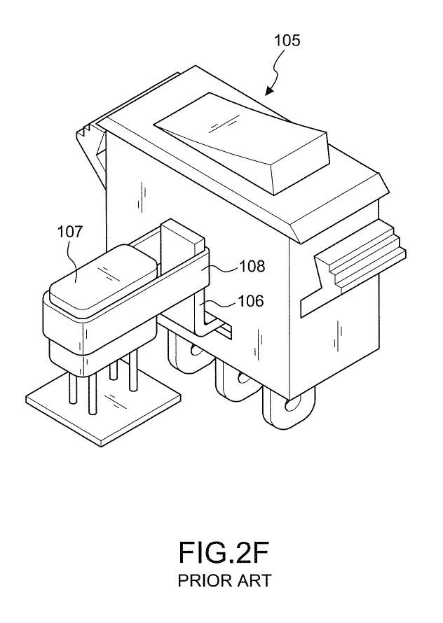

### DETAILED DESCRIPTION OF THE PREFERRED EMBODIMENT

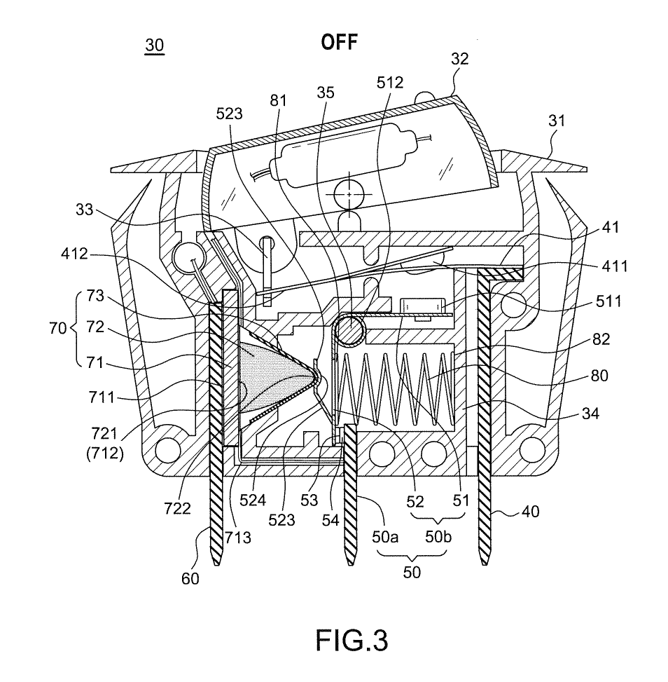

Referring to FIGS. 3-6, a preferred embodiment of the present invention includes a housing 31, a moving rod 33, an overvoltage protection sensor 70, and a spring 80.

The housing 31 has a press button 32, a first conductive plate 40, a second conductive plate 50, and a third conductive plate 60; the first conductive plate 40 has a binary alloy conductive spring leaf 41 and a first connecting point 411, and the second conductive plate 50 has a second connecting point 511 at top corresponding to the first connecting point 411.

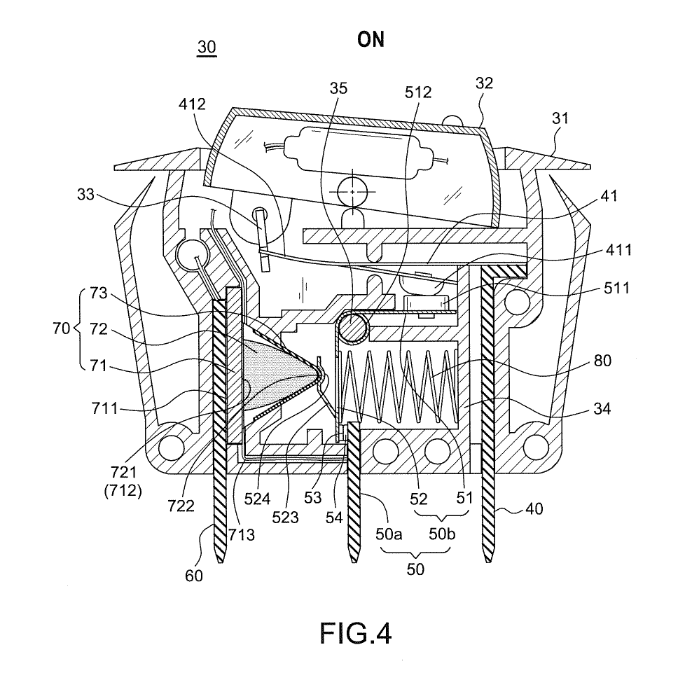

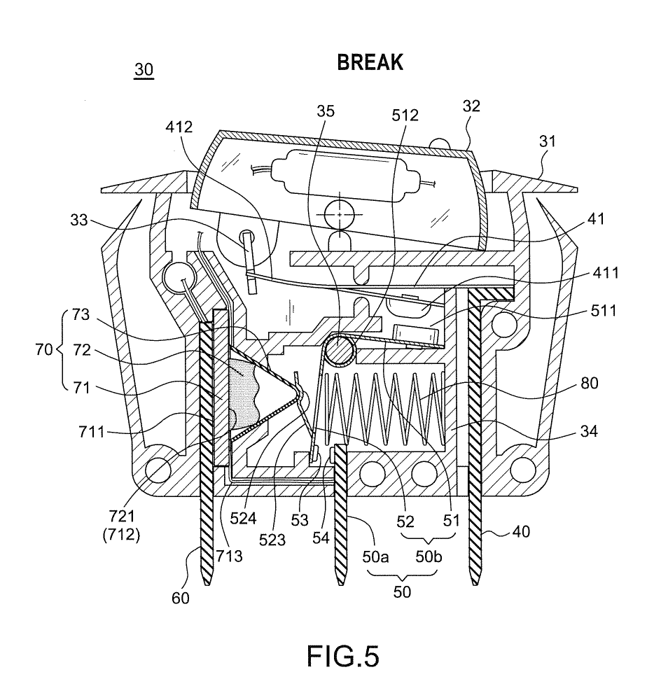

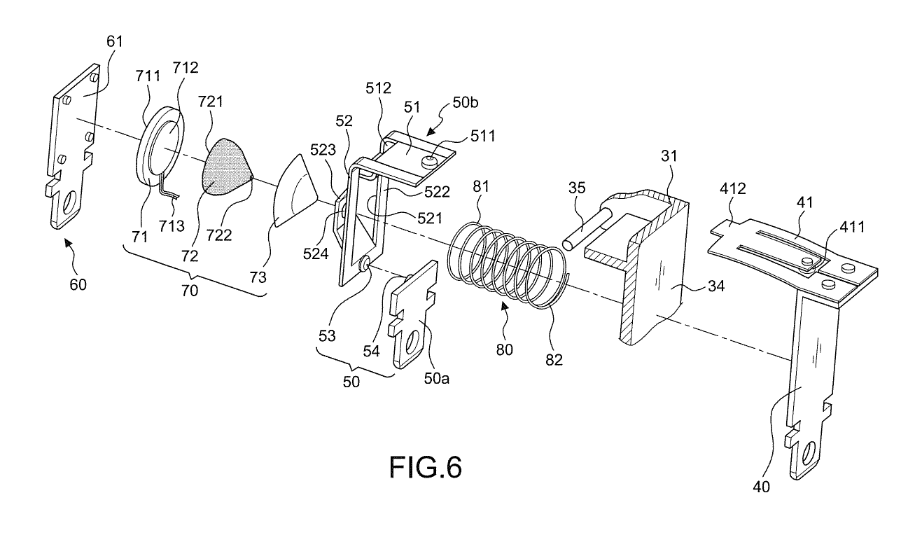

The moving rod 33 links up the bottom of the press button 32 with one end and a movable end 412 of the binary alloy conductive spring leaf 41 with the other end as shown in FIG. 4, whereby the press button 32 pressing the binary alloy conductive spring leaf 41 and connecting the first connecting point 411 and the second connecting point 511, turning on the switch, and when current overload happens the binary alloy conductive spring leaf 41 would deform due to high degree of temperature, moving the first connecting point 411 and the second connecting point 511 apart, thus turning off the switch, so as to form an overcurrent protection switch 30;

wherein the second conductive plate 50 includes an extending portion 50a stretching out the housing 31 and an operating portion 50b inside thereof; the operating portion 50b further has an upper section 51 fixed by the second connecting point 511 and a lower section 52 which includes a first side 521 and a second side 522 and is electrically connected to the upper section 51, as shown in FIG. 6 in an applicable embodiment; and the second side 522 is partially contacting the extending portion 50a via electrical connection but it is separable; in this embodiment, the upper section 51 and lower section 52 of the operating portion 50b are arranged in L-shape or curved shape, and the joint thereof has a hinge hole 512 for a pivot stick 35 from the housing 31 to engage, making the operating portion 50b as a seesaw.

In this embodiment, the overvoltage protection sensor 70 comprises a metal oxide varistor 71 and a thermosensitive piece 72. The metal oxide varistor 71 is circular and unwrapped but is not limited to such application. When receiving high voltages, it transforms the voltages into heat. It has a first surface 711 on one side and a second surface 712 on the other and links up to the extending portion 50a of the second conductive plate 50 via a conductive wire 713. The thermosensitive piece 72 is made of heat-sensitive materials, which would melt instantly when reaching a pre-determined temperature degree during operation, and the bottom 721 thereof fixes on the second surface 712 of the metal oxide varistor 71 by adhesive materials, further makes the first surface 711 of the metal oxide varistor 71 fits a contact surface 61 of the third conductive plate 60, forming an electrical contact. The front of said thermosensitive piece 72 faces and partially contacts the first side 521 of the lower section 52 in order to maintain the electrical connection.

In this embodiment, the heat-sensitive material of the thermosensitive piece 72 can be nonmetal like resin or agar, or it could be fusible alloy or metal compound, but still is not limited to such application. As long as the material melts and disconnects the device before reaching an exceeding degree of temperature, it is applicable. In a preferred embodiment, the thermosensitive piece 72 is conical as the bottom 721 arranged as a flat surface and the front a pointed end. The bottom thereof could further have fusible adhesive materials to fix it on the second surface 712 of the metal oxide varistor 71, facilitating the heat conduction.

The spring 80 has a first end 81 at one side and a second end 82 at the other and is arranged on the second side 522 of said lower section 52; the second end 82 thereof abuts a holding surface 34 arranged in the housing 31, providing the elastic force for the spring 80 to hold the position of the thermosensitive piece 72. With reference to FIG. 4, before the themosensitive piece 72 melts, the spring 80 keeps contracting in-between the lower section 52 and the extending portion 50a to maintain the electrical connection;

whereby the thermosensitive piece 72 melts when an overvoltage occurs and the temperature of the metal oxide varistor 71 rises up to the pre-determined degree while the switch is operating by the connection between the first connecting point 411 and the second connecting point 511, counterbalancing the elastic force and further displacing the operating portion 50b, therefore separating the first conductive plate 40 and the second conductive plate 50, turning off the switch.

Moreover, in an applicable embodiment, the first side 521 of the lower section 52 has a springy piece 523 contacting the thermosensitive piece 72 by fitting the front thereof into a positioning hole 524 on the springy piece 523. The springy piece 523 could be formed together with the lower section 52 in one-piece, or it could be replaced by a spring (not shown in the FIGS), even the entire lower section 52 could be designed as an elastic plate and thus replace the springy piece 523. The springy piece 523 also has a function of heat insulation in order to avoid possible melting of the thermosensitive piece 72 when the extending portion 50a is being welded during manufacture process. Besides, it could further have an insulation cap 73 at the front to prevent the possible melting mentioned before; the insulation cap 73 can also cover the melted thermosensitive piece 72 as in FIG. 5.

As stated above, the design of displacing distance of the springy piece 523 is shorter than the one of the spring 80 so that when the thermosensitive piece 72 melts the spring 80 can push the lower section 52 in a distance long enough to disconnect the device instantly for safety.

FIG. 5 is an illustration of the thermosensitive piece 72 melting when an overvoltage occurs and the temperature of the metal oxide varistor 71 rises up to the pre-determined degree while the switch is operating by the connection between the first connecting point 411 and the second connecting point 511; and the melting counterbalances the elastic force, turning off the switch. In this embodiment, the operating portion 50b is an independent element as is the extending portion 50a, made in rigid structure and arranged in L-shape or curved shape. When the switch is off, the first connecting point 411 and the second connecting point 511 are disconnecting, so are the third connecting point 53 and the fourth connecting point 54. But there are other applications available. For example, a flexible lower section 52 with an upper section 51 of rigid structure form the operating portion 50b; when the thermosensitive piece 72 melts, the spring 80 pushes the lower section 52 while the upper section 51 keeps in its position. In this way, the first connecting point 411 and the second connecting point 511 would not disconnect but the third connecting point 53 and the fourth connecting point 54 are disconnected. This is able to turn off the switch as well. In the embodiment, the second conductive plate 50 is arranged at bottom of the housing 31 but can also be arranged on either side thereof.

FIG. 6 is an exploded view of the major components in a preferred embodiment of the present invention. The structure that the thermosensitive piece 72 melts when the metal oxide varistor 71 rises up the temperature due to overvoltage has a vital feature that the thermosensitive piece 72 has a large contact surface adhered to the metal oxide varistor 71 by adhesive materials. The metal oxide varistor 71 is a non-ohmic conducting component that its electric resistance would change along with input voltages; the V-I characteristic curve diagram of it is therefore non-lineal. It is widely applied in electric circuits in order to protect the power system from damages of sudden overvoltage. In the present invention, the metal oxide varistor 71 rises up the temperature when receiving high voltages, and the thermosensitive piece 72 would melt instantly at a pre-determined degree due to large contact surface with it, counterbalancing the elastic force at the corresponding side of the spring 80 and further displacing the operating portion 50b and disconnects the first and second conductive plates 40, 50.

With structures disclosed above, the present invention complements the defect of a conventional overcurrent protection switch that it has to connect to a thermal fuse and a metal oxide varistor outside by disposing an overvoltage protection sensor 70 inside. When receiving high voltages, the operating portion 50b of second conductive plate 50 would be quickly displaced and thus turning off the output terminal. Meanwhile, the heating metal oxide varistor 71 combining with the contact with thermosensitive piece 72 melting in instant high temperature assures the switch to be turned off before reaching an exceeding high degree of temperature. The design of an overvoltage protection sensor 70 inside an overcurrent protection switch 30 has improved both safety and convenience of assembly.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An anti-lightning stroke overcurrent protection switch comprising:
a housing with a press button, a first conductive plate, a second conductive plate, and a third conductive plate; said first conductive plate having a binary alloy conductive spring leaf and a first connecting point and said second conductive plate having a second connecting point at top corresponding to said first connecting point;
a moving rod linking up the bottom of said press button with one end and a movable end of said binary alloy conductive spring leaf with the other end, whereby the press button pressing said binary alloy conductive spring leaf and connecting the first connecting point and the second connecting point, turning on the switch, and when current overload happens the binary alloy conductive spring leaf would deform due to high temperature, moving said first connecting point and the second connecting point apart, thus turning off the switch, so as to form an overcurrent protection switch;
wherein said second conductive plate includes an extending portion stretching out the housing and an operating portion inside thereof; said operating portion further has an upper section fixed by said second connecting point and a lower section which includes a first side and a second side and is electrically connected to said upper section; said second side is partially contacting the extending portion via electrical connection but is separable;
an overvoltage protection sensor comprising a metal oxide varistor and a thermosensitive piece; said metal oxide varistor being unwrapped and having a first surface on one side and a second surface on the other; said thermosensitive piece being made of heat-sensitive materials, which would melt instantly when reaching a pre-determined temperature degree during operation, and the bottom of the thermosensitive piece fitting the second surface of said metal oxide varistor, further making the first surface thereof fitting a contact surface of said third conductive plate, forming an electrical contact; the front of said thermosensitive piece facing and partially contacting the first side of said lower section;
a spring having a first end at one side and a second end at the other, and being arranged on the second side of said lower section; the second end thereof abutting a holding surface arranged in the housing, providing the elastic force for the spring to hold said thermosensitive piece;
whereby said thermosensitive piece would melt when an overvoltage occurs and the temperature of said metal oxide varistor rises up to the pre-determined degree while the switch is operating by the connection between the first connecting point and the second connecting point, counterbalancing the elastic force and further displacing the operating portion, therefore separating the first conductive plate and the second conductive plate, turning off the switch.

2. The anti-lightning stroke overcurrent protection switch as claimed in claim 1, wherein said upper section and lower section of the operating portion are arranged in L-shape or curved shape.

3. The anti-lightning stroke overcurrent protection switch as claimed in claim 2, wherein the joint of said upper section and lower section has a hinge hole for a pivot stick from the housing to engage, making the operating portion as a seesaw.

4. The anti-lightning stroke overcurrent protection switch as claimed in claim 3, wherein said lower section and extending portion are joined by a third connecting point and a fourth connecting point respectively.

5. The anti-lightning stroke overcurrent protection switch as claimed in claim 1, wherein said thermosensitive piece is conical as the bottom arranged as a flat surface and the front a pointed end.

6. The anti-lightning stroke overcurrent protection switch as claimed in claim 5, wherein said first side of the lower section has a springy piece contacting the thermosensitive piece by fitting the front thereof into a positioning hole on said springy piece.

7. The anti-lightning stroke overcurrent protection switch as claimed in claim 6, wherein said thermosensitive piece further has an insulation cap at the front.

8. The anti-lightning stroke overcurrent protection switch as claimed in claim 1, wherein said second conductive plate can be arranged at either the bottom or one side of the housing.
